(19) United States
(12) Patent Application Publication
(10) Pub. No.: US 2015/0379565 A1
(43) Pub. Date: Dec. 31, 2015

(54) SYSTEM AND METHOD FOR DETERMINING A TIME FOR TRANSMITTING AN ELECTRONIC REWARD TO A USER COMPUTING DEVICE

(71) Applicant: TOSHIBA TEC KABUSHIKI KAISHA, Tokyo (JP)

(72) Inventor: Kenya HIRAMATSU, Kita Tokyo (JP)

(21) Appl. No.: 14/753,785

(22) Filed: Jun. 29, 2015

(30) Foreign Application Priority Data
Jun. 30, 2014 (JP) 2014-134953

(51) Int. Cl. G06Q 30/02

(52) U.S. Cl. CPC G06Q 30/0253; G06Q 30/0209

(57) ABSTRACT

A system includes a processor and a communication unit. The processor is configured to track sales promotion information supplied to the user computing device, viewing of the sales promotion information at the user computing device, and electronic receipts for purchases of products by a user of the user computing device, and to determine, based on data tracked by the sales tracking module, whether or not conditions for transmitting the electronic reward to the user computing device has been satisfied. The communication unit is connected to the user computing device and a server for the application through a network. Upon determining that the conditions have been satisfied, the processor transmits the electronic reward to the server for the application through the communication unit, so that the user can be notified of the electronic reward through the user computing device while the user computing device is executing the application.

### CROSS-REFERENCE TO RELATED APPLICATION

This application is based upon and claims the benefit of priority from Japanese Patent Application No. 2014-134953, filed Jun. 30, 2014, the entire contents of which are incorporated herein by reference.

### FIELD

Embodiments described herein relate generally to a system and method for determining a time for transmitting an electronic reward to a user computing device.

### BACKGROUND

In the related art, an electronic receipt system transmits data of an electronic receipt for a purchase transaction at a store to a mobile computing device of a user who is involved in the purchase transaction. The user can recognize details of the purchase transaction by looking at a display unit of the mobile computing device displaying a screen of the electronic receipt.

Conventionally, a variety of sales promotions, such as advertisement, price discounts, and offer of reward points, is performed at stores based on a type of purchased products or a purchase total. Today, such sales promotions have been expanded into a virtual world. That is, the sales promotion may be performed in an application program such as a game operated in a computing device of the user. Within the virtual world of the game, a virtual reward can be redeemed. Linking a purchase transaction in the real world, in particular at stores, and offering the reward in the virtual world would be desirable.

### DESCRIPTION OF THE DRAWINGS

FIG. 1 illustrates a configuration of an electronic receipt system according to an embodiment.

FIG. 2 is a block diagram of a POS terminal in the electronic receipt system shown in FIG. 1.

FIG. 3 is a block diagram of an electronic receipt server in the electronic receipt system.

FIG. 4 is a block diagram of a management server in the electronic receipt system.

FIG. 5 illustrates a data structure of a membership table stored in the management server.

FIG. 6 illustrates a data structure of a purchase history table stored in the management server.

FIG. 7 illustrates a data structure of a sales promotion setting table stored in the management server.

FIG. 8 illustrates a data structure of a sales promotion history table stored in the management server.

FIG. 9 is a block diagram of a promotion server in the electronic receipt system.

FIG. 10 is a block diagram of an information supply server in the electronic receipt system.

FIG. 11 is a block diagram of a user terminal in the electronic receipt system.

FIG. 12 illustrates functional sections of the electronic receipt system relating to sales promotion processing according to the embodiment.

FIG. 13 illustrates functional sections of the electronic receipt system relating to electronic receipt processing according to the embodiment.

FIG. 14 illustrates functional sections of the electronic receipt system relating to reward offering processing according to the embodiment.

FIG. 15 is a sequence diagram of the sales promotion processing according to the embodiment.

FIG. 16 is a sequence diagram of the electronic receipt processing according to the embodiment.

FIG. 17 is a sequence diagram of the reward imparting processing according to the embodiment.

### DETAILED DESCRIPTION

In general, according to one embodiment, a system for determining a time for transmitting an electronic reward to a user computing device for display within an application installed and executed in the user computing device, includes a processor and a communication unit. The processor is configured with a sales tracking module to track: (i) sales promotion information supplied to the user computing device, (ii) viewing of the sales promotion information at the user computing device, and (iii) electronic receipts for purchases of products by a user of the user computing device, and with an electronic reward delivery module to determine, based on data tracked by the sales tracking module, whether or not conditions for transmitting the electronic reward to the user computing device have been satisfied. The communication unit is connected to the user computing device and a server for the application through a network. Upon determining that the conditions for transmitting the electronic reward to the user computing device have been satisfied, the processor transmits the electronic reward to the server for the application through the communication unit, so that the user can be notified of the electronic reward through the user computing device while the user computing device is executing the application.

An embodiment will be described with reference to the drawings.

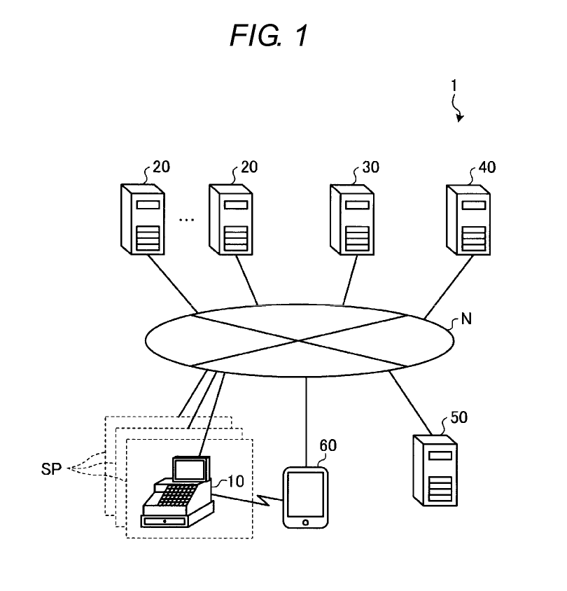

FIG. 1 illustrates an entire configuration of an electronic receipt system 1 according to an embodiment. As shown in FIG. 1, the electronic receipt system 1 includes a POS terminal 10, an electronic receipt server 20, a management server 30, a promotion server 40, an information supply server 50, and a user terminal 60. Here, each device configuring the electronic receipt system 1 is connected to a network N such as the Internet in a wireless or wired manner.

Hereinafter, each device configuring the electronic receipt system 1 will be described.

POS Terminal

First, the POS terminal 10 will be described. The POS terminal 10 is a merchandise sales data processing device and executes a merchandise sales data process. The POS terminal 10 is, for example, provided in a store SP such as a supermarket or a convenience store.

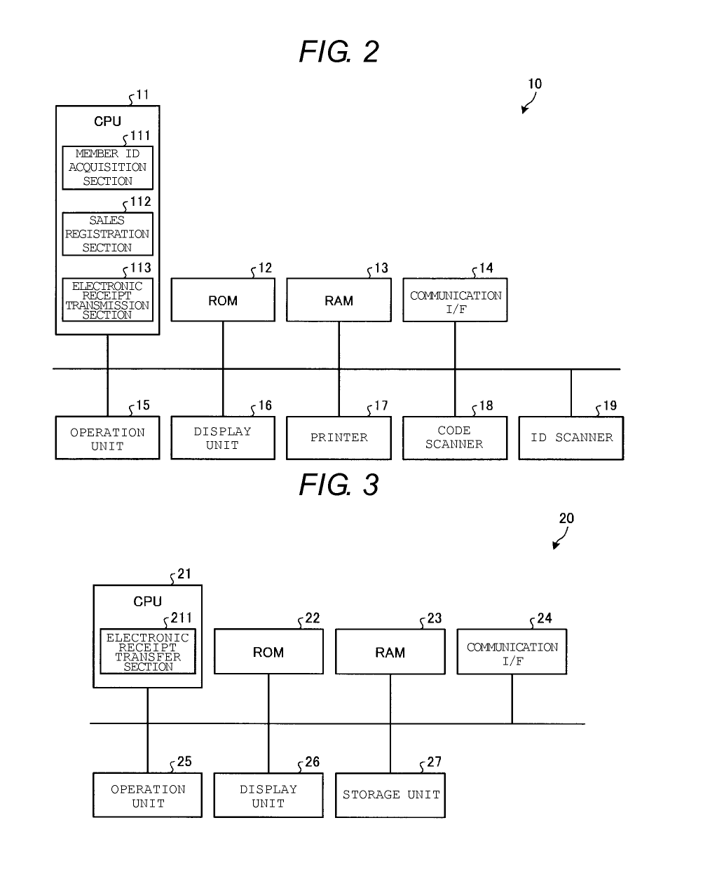

FIG. 2 is a block diagram of the POS terminal 10. As shown in FIG. 2, the POS terminal 10 includes a central processing unit (CPU) 11, a read only memory (ROM) 12, a random access memory (RAM) 13, a communication I/F 14, an operation unit 15, a display unit 16, a printer 17, a code scanner 18, and an ID scanner 19. The POS terminal 10 includes a clock device such as a real time clock (RTC) (not shown).

The ROM 12 stores various programs executed by the CPU 11 and various data. The RAM 13 temporarily stores data or a program, when the CPU 11 executes various programs. The CPU 11 generates functional sections (modules) such as a member ID acquisition section 111, a sales registration section 112, and an electronic receipt transmission section 113 by expanding the various programs stored in the ROM 12 to the RAM 13 and executing the expanded programs.

The communication I/F 14 is a communication interface that is configured to be connected to the network N. The POS terminal 10 may communicate with a device connected to the network N through the communication I/F 14.

The operation unit 15 is an input device such as a keyboard or a pointing device. Such a keyboard includes a numeric keypad with numbers, arithmetic operators, and a closing key for completing one transaction. The operation unit 15 receives an operation of an operator and outputs the operation content to the CPU 11.

The display unit 16 is a display device such as liquid crystal display (LCD). The display unit 16 displays various kinds of information such as transaction content, under the control of the CPU 11. The display unit 16 may include a display device for a customer, separately from a display device for an operator. The display unit 16 may have a touch panel. In this case, the touch panel functions as the operation unit 15.

The printer 17 is a printing device which performs printing on a sheet such as receipt paper. The printer 17 prints the transaction content of one transaction on the sheet, under the control of the CPU 11.

The code scanner 18 is a reading device which reads a code symbol such as a barcode. The code scanner 18 reads a code symbol printed on merchandise and outputs a merchandise ID contained in the code symbol to the CPU 11. Here, the merchandise ID is a merchandise identifier of a product, such as a JAN code, for example.

The ID scanner 19 is a reading device which reads member IDs assigned to customers (members). Here, the member ID is a unique identifier assigned to the customer (member) who completed membership registration, with respect to the electronic receipt system 1. Such a member ID is held in a storage medium such as a magnetic card, IC card, or the user terminal 60 carried by the member.

The ID scanner 19 reads the member ID from the storage medium presented by the customer and outputs the member ID to the CPU 11. A method of reading the member ID is not particularly limited. For example, when the member ID is held in a magnetic card, a magnetic card reader is used as the ID scanner 19. When the member ID is held in an IC card, an IC card reader is used as the ID scanner 19. When the member ID is held in the user terminal 60, a communication device which may communicate with the user terminal 60 by a communication method such as near field communication (NFC) is used as the ID scanner 19. When the member ID is presented as a code symbol on a paper medium or display screen of the user terminal 60, the code scanner 18 may be used as the ID scanner 19.

The POS terminal 10 performs sales registration of merchandise purchased by a customer. The POS terminal 10 transmits electronic receipt information including transaction content of one transaction, to the electronic receipt server 20 with the member ID of the customer. A merchandise ID, purchase date and time, a purchase place (store), and the like are included in the electronic receipt information. In addition, the POS terminal 10 outputs details of the transaction as a paper receipt from the printer 17, according to a request from the customer.

Electronic Receipt Server

Next, the electronic receipt server 20 will be described. The electronic receipt server 20 is provided for a company operating one or more stores SP. The electronic receipt server 20 functions as a receipt management server for the company and manages electronic receipt information for the company. A head office server of a POS system having functions such as sales management, sales analysis, or inventory management of the company may be used as the electronic receipt server 20.

FIG. 3 is a block diagram of the electronic receipt server 20. As shown in FIG. 3, the electronic receipt server 20 includes a CPU 21, a ROM 22, a RAM 23, a communication I/F 24, an operation unit 25, a display unit 26, and a storage unit 27. The electronic receipt server 20 includes a clock device such as an RTC (not shown).

The ROM 22 stores various programs executed by the CPU 21 and various data. The RAM 23 temporarily stores data or a program, when the CPU 21 executes various programs. The CPU generates functional sections (modules) such as an electronic receipt transfer section 211 by expanding the various programs stored in the ROM 22 or the storage unit 27 to the RAM 23 and executing the expanded programs.

The communication I/F 24 is a communication interface that is configured to be connected to the network N. The electronic receipt server 20 may communicate with a device connected to the network N through the communication I/F 24. The operation unit 25 is an input device such as a keyboard or a pointing device. The operation unit 25 receives an operation of an operator and outputs the operation content to the CPU 21. The display unit 26 is a display device such as an LCD. The display unit 26 displays various kinds of information, under the control of the CPU 21.

The storage unit 27 is a storage device such as a hard disk drive (HDD) or a solid state drive (SSD). The storage unit 27 stores various programs executed by the CPU 21 and various data.

The electronic receipt server 20 transfers electronic receipt information and member IDs transmitted from the corresponding POS terminal 10 of the store SP to a management server 30.

Management Server

Next, the management server 30 will be described. The management server 30 collectively manages the electronic receipt information of multiple companies operating the stores SP. The management server 30 is, for example, managed by a third party organization other than a company which manages the electronic receipt information using the electronic receipt server 20. Alternatively, the electronic receipt server 20 may also be managed by a third party organization.

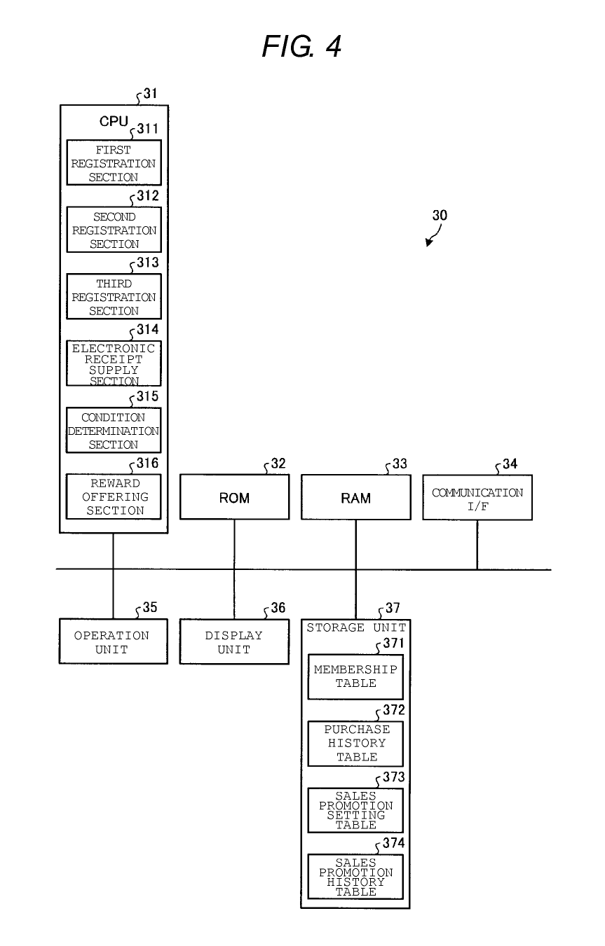

FIG. 4 is a block diagram of the management server 30. As shown in FIG. 4, the management server 30 includes a CPU 31, a ROM 32, a RAM 33, a communication I/F 34, an operation unit 35, a display unit 36, and a storage unit 37. The management server 30 includes a clock device such as an RTC (not shown).

The ROM 32 stores various programs executed by the CPU 31 and various data. The RAM 33 temporarily stores data or a program, when the CPU 31 executes various programs. The CPU 31 generates functional sections (modules) such as a first registration section 311, a second registration section 312, a third registration section 313, an electronic receipt supply section 314, a condition determination section 315, and a reward offering section 316 by expanding the various programs stored in the ROM 32 or the storage unit 37 to the RAM 33 and executing the expanded programs.

The communication I/F 34 is a communication interface that is configured to be connected to the network N. The management server 30 may communicate with a device connected to the network N through the communication I/F 34. The operation unit 35 is an input device such as a keyboard or a pointing device. The operation unit 35 receives an operation of an operator and outputs the operation content to the CPU 31. The display unit 36 is a display device such as an LCD. The display unit 36 displays various kinds of information, under the control of the CPU 31.

The storage unit 37 is an HDD or an SSD. The storage unit 37 stores various programs executed by the CPU 31 and various data. The storage unit 37 stores tables (database) for various data relating to the electronic receipt system. Examples of such tables include a membership table 371, a purchase history table 372, a sales promotion setting table 373, and a sales promotion history table 374.

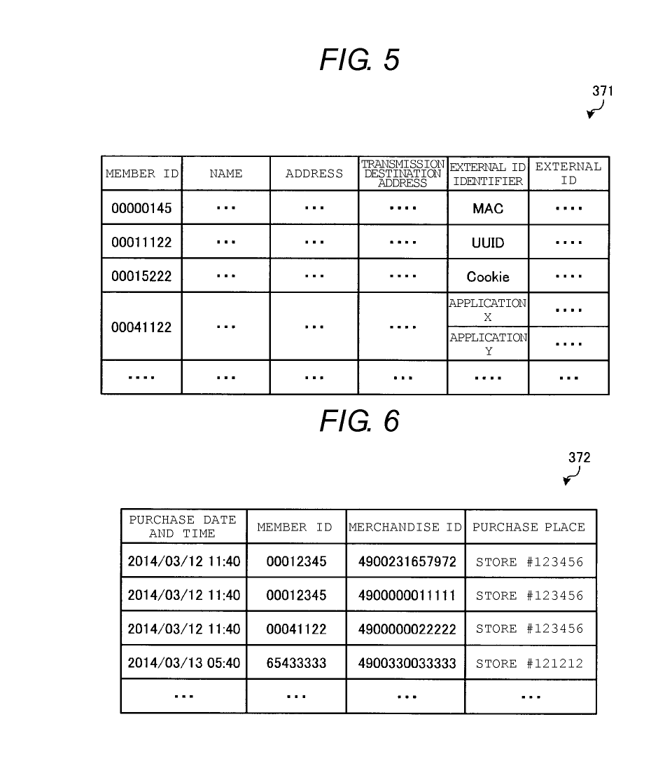

The membership table 371 is a data table for managing information (member information) relating to a customer (member) who has completed the membership registration. FIG. 5 illustrates a data configuration of the membership table 371. As shown in FIG. 5, the membership table 371 includes columns for storing a member ID, name, an address (home address), a transmission destination address, an external ID identifier, and an external ID.

Here, unique character string or numbers assigned at the time of the membership registration are stored in the column of the member ID. Name and an address input by the member at the time of the membership registration are stored in the column of name and the column of address, respectively. Address information of the user terminal 60, which is set as a transmission destination of the electronic receipt or reward information, is stored in the column of the transmission destination address. As the address information, an email address or a phone number (short message service) maybe used, for example.

In the external ID classification, classification of an identifier (hereinafter, referred to as external ID) assigned to the member other, which is different from the member ID is stored. For example, a MAC address (MAC) or a universally unique identifier (UUID) of the user terminal 60 held by the member is included in the external ID classification. An application ID such as an application name of an application program (hereinafter, referred to as an application) such as games installed in the user terminal 60 of the member is also included.

The external ID, which is an identifier of the external ID classification, is stored in the column of the external ID. When the external ID classification is MAC address or UUID, corresponding numbers or character string are stored. For example, when the external ID classification is the application ID, a user ID assigned to a user is accommodated.

Among these kinds of the member information, the member ID is registered at the time of the member registration. The name, the address, the transmission destination address, the external ID identifier, and external ID may be registered at the time of the member registration or may be registered after the member registration. As a method of registering the external ID identifier and external ID, various registration methods may be used. For example, the member ID and the external ID (external ID identifier) may be included in sales promotion history information (which will be described below) transmitted from the information supply server 50 or the user terminal 60. In this case, the management server 30 registers the external ID (external ID identifier) received with the member ID in correlation with the corresponding member ID in the membership table 371.

The data configuration of the membership table 371 is not limited to the example of FIG. 5. Some or all columns of the columns for the name, the address, the transmission destination address, the external ID identifier, and external ID may be empty.

The purchase history table 372 is a data table for managing the electronic receipt information. FIG. 6 illustrates a data configuration of the purchase history table 372. As shown in FIG. 6, the purchase history table 372 includes columns for storing date and time, a member ID, a merchandise ID, and a purchase place, which are included in the electronic receipt information. Here, a store ID of the store SP, in which the sales registration has been performed, is stored in the column of the purchase place.

When the electronic receipt information and the member ID are received from the electronic receipt server 20, the management server 30 registers the received information to the purchase history table 372. In the present embodiment, the electronic receipt information is received through the electronic receipt server 20, but the electronic receipt information may be directly received from POS terminal 10.

The management server 30 supplies the electronic receipt information correlated to the member ID of the customer to the transmission destination address associated with the member ID, according to the request from the customer.

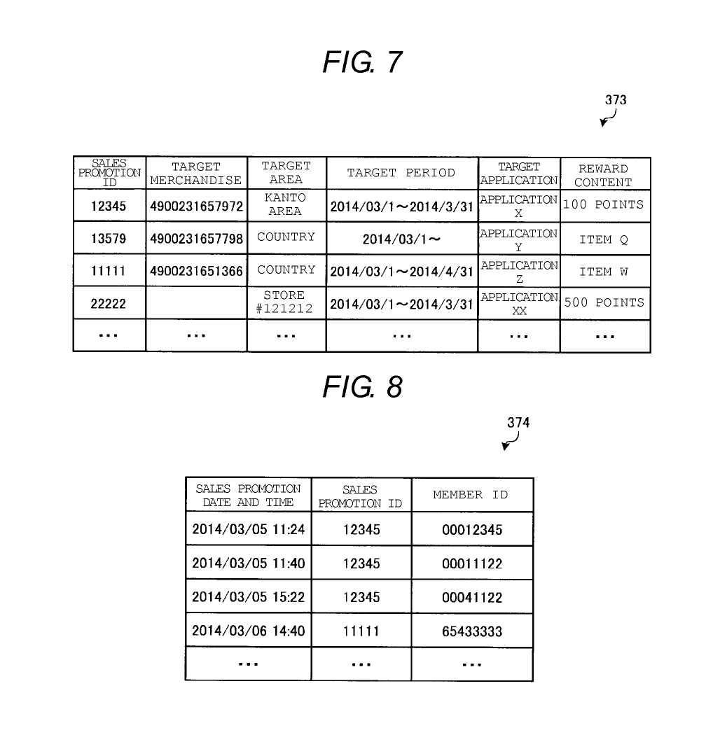

The sales promotion setting table 373 is a data table for managing setting information (sales promotion setting information) relating to the sales promotion. FIG. 7 illustrates a data configuration of the sales promotion setting table 373. As shown in FIG. 7, the sales promotion setting table 373 includes columns for a sales promotion ID, target merchandise, a target area, a target period, a target application, and reward content.

Character string or numbers for identifying each sales promotion are stored in the column of the sales promotion ID. A merchandise ID of the merchandise which is a target of the sales promotion is stored in the column of the target merchandise. An area or a store (store ID) in which the sales promotion will be performed is stored in the column of the target area. A period of the sales promotion is stored in the column of the target period. An application ID of an application used for the sales promotion is stored in the column of the target application. Reward content to be provided to a customer who purchased the target merchandise during the target period or to a customer who visited the store in the target area is stored in the column of the reward content. Here, virtual articles such as virtual currency or virtual items used in the application stored as the target application may be stored in the column of the reward content.

Among these kinds of the sales promotion setting information, the target merchandise, the target area, and the target period are used as provision conditions to offer the reward (reward content). In addition, by leaving the column of the target merchandise blank and setting the target area as a specific store, the corresponding store may be the sales promotion target (target store).

When the sales promotion setting information described above is received from the promotion server 40, the management server 30 registers contents included in the received sales promotion setting information in the sales promotion setting table 373.

The sales promotion history table 374 is a data table for managing information (sales promotion history information) relating to a customer who has acquired sales promotion information. FIG. 8 illustrates a data configuration of the sales promotion history table 374. As shown in FIG. 8, the sales promotion history table 374 includes columns for sales promotion date and time, a sales promotion ID, and a member ID.

Here, date and time when the customer has acquired the sales promotion information are stored in the column of the sales promotion date and time. A sales promotion ID of the sales promotion information acquired by the customer is stored in the column for the sales promotion ID. A member ID of the customer who has acquired the sales promotion information is stored in the column for the member ID.

When the sales promotion history information described above is received from the information supply server 50 or the user terminal 60, the management server 30 registers contents included in the received sales promotion history information in the sales promotion history table 374.

In the present embodiment, the member ID may not be included in the transmitted sales promotion history information and, instead, the external ID and the external ID identifier may be included therein. In this case, the management server 30 (CPU 31) obtains a member ID corresponding to the external ID with reference to the membership table 371 and registers the member ID in the sales promotion history table 374. When the corresponding external ID is not stored in the membership table 371, the registration is performed in the sales promotion history table 374 by leaving the member ID blank.

As described above, when the plurality of identifiers (member ID and external ID) of the same customer are registered in the membership table 371, the management server 30 (CPU 31) functions as a management section which associates records relating to the same customer registered different identifiers in each table, with each other. Accordingly, the customer (member) may use the electronic receipt system using any one of the plurality of his or her identifiers (member ID and external ID), and therefore, usability of the electronic receipt system may be increased.

When it is confirmed that the customer who has acquired the sales promotion information satisfies the provision conditions, based on the information stored in each table described above, the management server 30 offers the reward corresponding to the reward content.

Promotion Server

Next, the promotion server 40 will be described. The promotion server 40 manages the sales promotion contents such as an advertisement. The promotion server 40 is, for example, managed by a company manufacturing and selling merchandise or an advertising agency which creates an advertisement or the like.

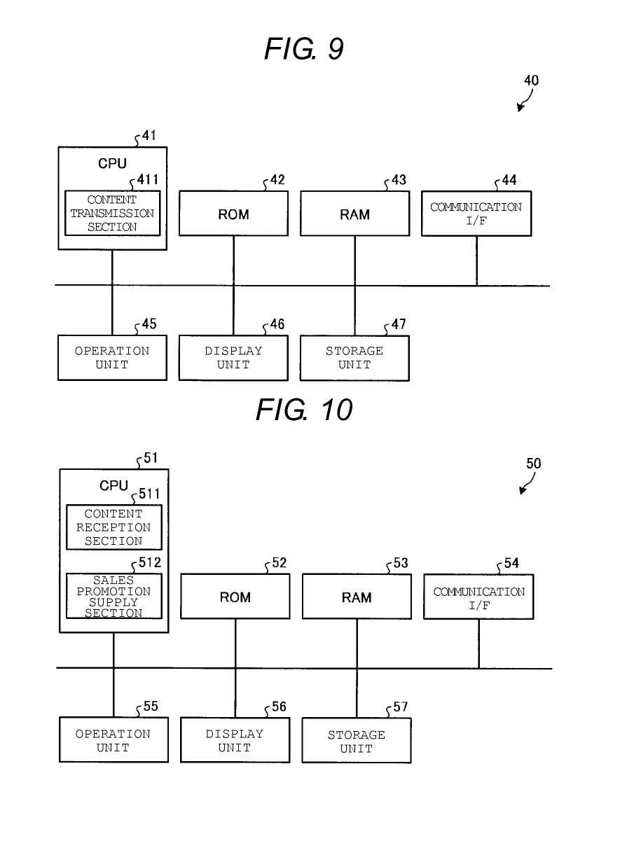

FIG. 9 is a block diagram of the promotion server 40. As shown in FIG. 9, the promotion server 40 includes a CPU 41, a ROM 42, a RAM 43, a communication I/F 44, an operation unit 45, a display unit 46, and a storage unit 47. The promotion server 40 includes a clock device such as an RTC (not shown).

The ROM 42 stores various programs executed by the CPU 41 and various data. The RAM 43 temporarily stores data or a program, when the CPU 41 executes various programs. The CPU 41 generates functional sections (modules) such as a content transmission section 411 by expanding the various programs stored in the ROM 42 or the storage unit 47 to the RAM 43 and executing the expanded programs.

The communication I/F 44 is a communication interface that is configured to be connected to the network N. The promotion server 40 may communicate with a device connected to the network N through the communication I/F 44. The operation unit 45 is an input device such as a keyboard or a pointing device. The operation unit 45 receives an operation of an operator and outputs the operation content to the CPU 41. The display unit 46 is a display device such as an LCD. The display unit 46 displays various kinds of information, under the control of the CPU 41.

The storage unit 47 is an HDD or an SSD. The storage unit 47 stores various programs executed by the CPU 41 and various data. The storage unit 47 stores the sales promotion information and the sales promotion setting information (not shown).

Here, the sales promotion information is information for promoting specific merchandise or store such as an advertisement. Specifically, the sales promotion information includes content for advertising the sales promotion target, such as the specific merchandise (target merchandise) or the specific store (target store). The sales promotion information includes reward content of a reward to be transmitted to the user terminal 60 that stores the application on which the sales promotion information and provision conditions to offer the reward are used. Such content may be represented by characters or an image (still image or moving image). The sales promotion information includes a sales promotion ID of the corresponding sales promotion information.

The sales promotion setting information is setting information defining conditions to provide the sales promotion information. Specifically, as shown in FIG. 7, the sales promotion setting information is information such as the sales promotion ID, the target merchandise, the target area, the target period, the target application, and the reward content. The same sales promotion ID is assigned to the corresponding sales promotion information and sales promotion setting information.

The promotion server 40 transmits a set of the sales promotion information and sales promotion setting information to the information supply server 50. The promotion server 40 also transmits the sales promotion setting information to the management server 30.

Information Supply Server

Next, the information supply server 50 will be described. The information supply server 50 supplies (delivers) the sales promotion information to the user terminal 60 through the network N.

FIG. 10 is a block diagram of the information supply server 50. As shown in FIG. 10, the information supply server 50 includes a CPU 51, a ROM 52, a RAM 53, a communication I/F 54, an operation unit 55, a display unit 56, and a storage unit 57. The information supply server 50 includes a clock device such as an RTC (not shown).

The ROM 52 stores various programs executed by the CPU 51 and various data. The RAM 53 temporarily stores data or a program, when the CPU 51 executes various programs. The CPU 51 generates functional sections (modules) such as a content reception section 511 and a sales promotion supply section 512 by expanding the various programs stored in the ROM 52 or the storage unit 57 to RAM 53 and executing the expanded programs.

The communication I/F 54 is a communication interface that is configured to be connected to the network N. The information supply server 50 may communicate with a device connected to the network N through the communication I/F 54. The operation unit 55 is an input device such as a keyboard or a pointing device. The operation unit 55 receives an operation of an operator and outputs the operation content to the CPU 51. The display unit 56 is a display device such as an LCD. The display unit 56 displays various kinds of information, under the control of the CPU 51.

The storage unit 57 is an HDD or an SSD. The storage unit 57 stores various programs executed by the CPU 51 and various data. The storage unit 57 stores the sales promotion information and the sales promotion setting information transmitted from the promotion server 40.

The information supply server 50 receives the sales promotion information and the sales promotion setting information from the promotion server 40. Based on the sales promotion setting information, the information supply server 50 supplies the sales promotion information having the same sales promotion ID as that of the corresponding sales promotion setting information to the user terminal 60.

User Terminal

The user terminal 60 will be described. The user terminal 60 is a terminal device owned by a customer who uses the electronic receipt system 1. In the present embodiment, as the user terminal 60 a portable computer such as a smart phone is used, but there is no limitation. For example, a stationary computer such as a personal computer (PC) may be used.

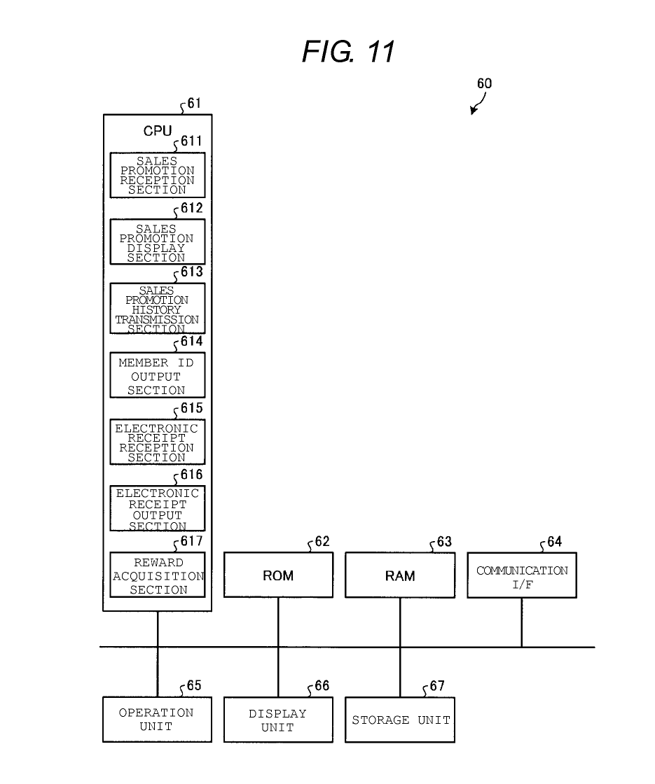

FIG. 11 is a block diagram of the user terminal 60. As shown in FIG. 11, the user terminal 60 includes a CPU 61, a ROM 62, a RAM 63, a communication I/F 64, an operation unit 65, a display unit 66, and a storage unit 67. The user terminal 60 includes a clock device such as an RTC (not shown).

The ROM 62 stores various programs executed by the CPU 61 and various data. The RAM 63 temporarily stores data or a program, when the CPU 61 executes various programs. The CPU 61 generates functional sections (modules) such as a sales promotion reception section 611, a sales promotion history transmission section 613, a member ID output section 614, an electronic receipt reception section 615, and an electronic receipt output section 616 by expanding the various programs stored in the ROM 62 or the storage unit 67 to the RAM 63 and executing the expanded programs.

The communication I/F 64 is a communication interface that is configured to be connected to the network N. The user terminal 60 may communicate with a device connected to the network N through the communication I/F 64. A communication interface which may perform short-range communication such as NFC may be used as the communication I/F 64.

The operation unit 65 is an input device such as a keyboard or a pointing device. The operation unit 65 receives an operation of an operator and outputs the operation content to the CPU 61. The display unit 66 is a display device such as an LCD. The display unit 66 displays various kinds of information, under the control of the CPU 61.

The storage unit 67 is an HDD or an SSD. The storage unit 67 stores various programs executed by the CPU 61 and various data. The storage unit 67, for example, stores application such as a game that is configured to be played on the user terminal 60. In addition, the storage unit 67 stores a member ID or an external ID of the user.

The user terminal 60 displays various screens relating to the application on the display unit 66 by activating the application stored in the storage unit 67 according to instruction through the operation unit 65. The user terminal acquires the sales promotion information from the information supply server 50 and displays the sales promotion information in a predetermined area of the application. When the predetermined operation with respect to the sales promotion information is received, the user terminal 60 transmits the sales promotion history information regarding the reception of the operation to the management server 30. In addition to the date and time when the sales promotion information has been acquired (sales promotion date and time) and the sales promotion ID included in the sales promotion information, the member ID and the external ID (external ID identifier) is included in the sales promotion history information. The sales promotion history information may be transmitted to the management server 30 through the information supply server 50.

The user terminal 60 performs proximity communication with the ID scanner 19 of the POS terminal 10, and transmits the information such as the member ID to the POS terminal 10. When electronic payment information for an electronic payment is stored in the user terminal 60, the user terminal 60 may also transmit the electronic payment information to the POS terminal 10.

The user terminal 60 acquires the electronic receipt information from the management server 30, and outputs the electronic receipt information to the display unit 66.

Next, a functional configuration of each device will be described.

[Sales Promotion Processing]

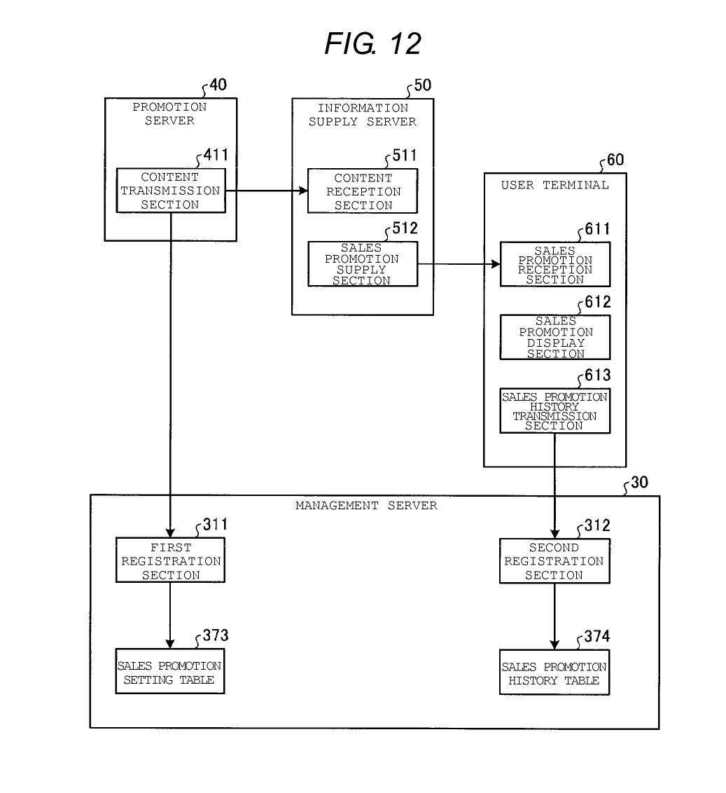

A functional configuration related to sales promotion processing, such as supply of the sales promotion information and collection of the sales promotion history information, will be described. FIG. 12 illustrates the functional configuration relating to the sales promotion processing in the electronic receipt system 1.

As shown in FIG. 12, the promotion server 40 includes the content transmission section 411 as a functional section for the sales promotion. The information supply server 50 includes the content reception section 511 and the sales promotion supply section 512 as the functional sections for the sales promotion. The user terminal 60 includes the sales promotion reception section 611, a sales promotion display section 612, and the sales promotion history transmission unit section as the functional sections for the sales promotion. The management server 30 includes the first registration section 311 and the second registration section 312 as the functional sections for the sales promotion.

The content transmission section 411 of the promotion server 40 reads out the sales promotion information and the sales promotion setting information having the same sales promotion ID from the storage unit 47, and transmits the read information to the information supply server 50. The content transmission section 411 also transmits the sales promotion setting information read out from the storage unit 47 to the management server 30.

Here, in the promotion server 40, timing of transmitting the sales promotion information and the sales promotion setting information is not particularly limited. The sales promotion information and the sales promotion setting information, for example, may be transmitted at the timing when the sales promotion information and the sales promotion setting information are stored in the storage unit 47 or at a predetermined timing. Alternatively, the sales promotion information and the sales promotion setting information may be transmitted according to the operation of the operator through the operation unit 45. The transmission of the information to the management server 30 and the information supply server 50 may be performed at the same time or may be performed at the different timings.

The first registration section 311 of the management server 30 receives the sales promotion setting information transmitted from the promotion server 40. The first registration section 311 registers various kinds of information included in the received sales promotion setting information to the corresponding columns of the sales promotion setting table 373 (see FIG. 7).

The content reception section 511 of the information supply server 50 receives the sales promotion information and the sales promotion setting information transmitted from the promotion server 40. The content reception section 511 stores the received sales promotion information and the sales promotion setting information in the storage unit 57.

The sales promotion supply section 512 of the information supply server 50 supplies the sales promotion information having the same sales promotion ID as that of the sales promotion setting information to the user terminal 60, based on the sales promotion setting information. Specifically, the sales promotion supply section 512 supplies the sales promotion information of the sales promotion ID correlated to the application ID, to the user terminal 60 that stores the application of the application ID set in the sales promotion setting information. A target for supplying the sales promotion information may be limited based on the other conditions set in the sales promotion setting information. For example, when a predetermined period (target period) is determined in the sales promotion setting information, the sales promotion supply section 512 limits a period for supplying the sales promotion information based on the target period.

Here, a method of supplying the sales promotion information is not particularly limited. A pull-type supply method of supplying the sales promotion information corresponding to the application ID according to notification of the application ID from the user terminal 60 may be used. Alternatively, a push-type supply method of supplying the sales promotion information to the user terminal 60 from the information supply server 50 at a predetermined timing may be used. In a case of the push-type supply method, the information supply server 50 acquires the application ID of the application being executed in the user terminal 60 or held in the user terminal 60 through the communication with the user terminal 60.

Additional information for requesting the user terminal 60 to perform a predetermined operation on the user terminal 60 is added to the sales promotion information supplied by the sales promotion supply section 512. The additional information, for example, includes first information for acquiring an identifier of an owner (customer) from the user terminal 60 and second information for transmitting the sales promotion history information to the management server 30. A method of obtaining the first information and the second information is not particularly limited, and well-known and publically used technologies may be used.

The first information may be a script for automatically acquiring the member ID or the external ID stored in the user terminal 60, for example. In addition, the first information maybe an input form for prompting a customer to input the member ID or the external ID. The identifier which is a target to be acquired is the external ID (external ID classification) such as the MAC address, the UUID, the application ID and the user ID of the application on which the sales promotion information is used, in addition to the member ID of the user. To acquire the member ID or the external ID, customer permission may need to be obtained. When the permission regarding the acquisition of the member ID or the external ID is set in advance, the notification to the customer may not be performed and the acquisition may be automatically performed.

The second information may be, for example, a script for commanding the user terminal 60 to automatically transmit the sales promotion history information. In addition, the second information maybe a transmission form for prompting a customer to perform the transmission of the sales promotion history information. To transmit the sales promotion history information, customer permission may need to be obtained. When the permission regarding the transmission of the sales promotion history information is set in advance, the notification to the customer may not be performed and the transmission may be automatically performed.

With the second information, the user terminal 60 which has acquired the sales promotion information transmits the sales promotion history information indicating the acquisition thereof to the management server 30. Since the information supply server 50 collects the sales promotion history information from the user terminal 60, the sales promotion history information may be transmitted to the management server 30 through the information supply server 50. When information corresponding to the additional information described above is included in the sales promotion information supplied from the promotion server 40, the sales promotion information may be transmitted as it is.

The sales promotion reception section 611 of the user terminal 60 receives (acquires) the sales promotion information supplied from the information supply server 50. Specifically, the sales promotion reception section 611 cooperates with the application being executed in the user terminal 60, and acquires the sales promotion information supplied to the application. When the sales promotion information is acquired by the push-type method, the sales promotion reception section 611 transmits the application ID of the application to the information supply server 50 at the timing when the activation of the application or the predetermined operation is performed.

The sales promotion display section 612 of the user terminal 60 displays the sales promotion information acquired by the sales promotion reception section 611 on the display unit 66. Specifically, the sales promotion display section 612 cooperates with the application being executed in the user terminal 60 and displays the sales promotion information on the screen relating to the application.

Here, a method of displaying the sales promotion information is not particularly limited. The sales promotion information may be displayed in a predetermined region of the screen in a form of a banner, for example. When the specific operation is performed, a screen for the sales promotion information may be displayed. When the application is a game or the like, the sales promotion information may be displayed on a purchase screen for purchasing virtual items with virtual currency used in the application. When the sales promotion information is displayed on the purchase screen, it is possible to increase user's interest in the sales promotion information by setting the reward content relating to the sales promotion information as the virtual articles such as virtual currency or virtual items. When the sales promotion information is displayed, the content for advertising the sales promotion target is displayed along with the content for showing the reward content and the imparting conditions.

The sales promotion history transmission section 613 of the user terminal 60 transmits the sales promotion history information indicating that the operator (customer) of the user terminal 60 has viewed the sales promotion information, to the management server 30. Specifically, when the predetermined operation for the sales promotion information is received, the sales promotion history transmission section 613 determines that the operator has viewed the sales promotion history information. The sales promotion history transmission section 613 acquires and transmits the current date and time (sales promotion date and time), and the member ID, the external ID, along with the sales promotion ID included in the sales promotion information that is determined to be viewed, as the sales promotion history information.

Here, a method of determining the viewing is not particularly limited. When the sales promotion information is displayed as a banner, for example, the determination of the viewing may be performed according to whether or not the operation for the banner is performed. When a screen for the sales promotion information is displayed by a predetermined operation, the determination of the viewing may be performed according to whether or not the operation is performed. When the sales promotion information is displayed on a purchase screen of an item, the determination of the viewing may be performed according to whether or not the operation for the sales promotion information is performed. When the sales promotion information is a video image, the determination of the viewing may be performed according to whether or not the video image is played.

The sales promotion history transmission section 613 acquires the member ID or the external ID, which are included in the sales promotion history information, from the own apparatus (user terminal 60), based on the additional information added to the sales promotion information. Here, when both or one of the member ID and the external ID is acquired, the acquired ID is included in the sales promotion history information and transmitted. When it is difficult to acquire both the member ID and the external ID, the sales promotion history information including the sales promotion date and time and the sales promotion ID is transmitted. The transmission of the sales promotion history information is performed based on the additional information added to the sales promotion information.

The second registration section 312 of the management server 30 receives the sales promotion history information transmitted from the user terminal 60. The second registration section 312 registers various kinds of information included in the received sales promotion history information in the corresponding columns of the sales promotion history table 374 (see FIG. 8).

[Electronic Receipt Processing]

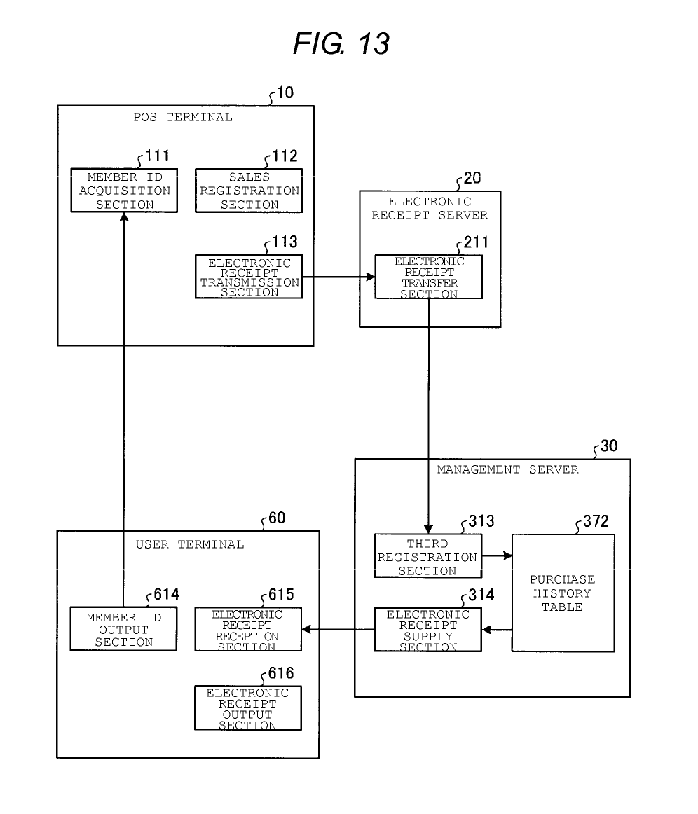

Next, a functional configuration of the electronic receipt system relating to electronic receipt processing will be described. FIG. 13 illustrates the functional configuration relating to the electronic receipt processing in the electronic receipt system 1.

As shown in FIG. 13, the POS terminal 10 includes the member ID acquisition section 111, the sales registration section 112, and the electronic receipt transmission section 113 as functional sections related to the electronic receipt processing. The electronic receipt server 20 includes the electronic receipt transfer section 211 as a functional section related to the electronic receipt processing. The management server 30 includes the third registration section 313 and the electronic receipt supply section 314 as functional sections related to the electronic receipt processing. The user terminal 60 includes the member ID output section 614, the electronic receipt reception section 615, and the electronic receipt output section 616 as functional sections related to the electronic receipt processing.

The member ID acquisition section 111 of the POS terminal 10 acquires the member ID from the user terminal 60 of the customer through the ID scanner 19.

The member ID output section 614 of the user terminal 60 communicates with the member ID acquisition section 111 through the communication I/F 64, and outputs the member ID held by the own apparatus to the POS terminal 10. The acquisition target of the member ID is not limited to the user terminal 60, and a magnet card or an IC card may be used instead. The member ID output section 614 may output the member ID by displaying a code symbol of the member ID on the display unit 66. In this case, the member ID acquisition section 111 of the POS terminal 10 acquires the member ID through the code scanner 18.

The sales registration section 112 of the POS terminal 10 reads merchandise information such as a merchandise name or a sales price of merchandise having the merchandise ID read by the code scanner 18, from a merchandise master (not shown), and performs the sales registration of the merchandise using the merchandise information. When the sales promotion is set for the specific merchandise or the store, the sales registration section 112 offers a promotion service such as discount to the customer (member). Here, the sales promotion set in the POS terminal 10 is based on the content of the sales promotion setting information. The merchandise sales data process relating to the sales registration of the merchandise is the same as process in the well-known technology, and therefore the description thereof will be omitted.

The electronic receipt transmission section 113 of the POS terminal 10 transmits the electronic receipt information including details of one transaction registered by the sales registration section 112 to the electronic receipt server 20. More specifically, the electronic receipt transmission section 113 transmits the merchandise ID of each merchandise subjected to the sales registration, the date and time when the sales registration is completed (purchase date and time), the member ID acquired by the member ID acquisition section 111, and the store ID previously set in the own apparatus to the management server 30 as the electronic receipt information. When the member ID is not acquired, the electronic receipt transmission section 113 transmits the electronic receipt information by leaving the column of the member ID blank.

The electronic receipt transfer section 211 of the electronic receipt server 20 receives the electronic receipt information transmitted from the POS terminal 10. The electronic receipt transfer section 211 transmits (transfers) the received electronic receipt information to the management server 30. The timing of transferring the electronic receipt information to the management server 30 is not particularly limited. For example, the electronic receipt information may be transferred each time the electronic receipt information is received. In addition, the electronic receipt information received during a predetermined period (for example, for one day) may be stored in the storage unit 27 or database and the stored electronic receipt information may be transferred at a predetermined timing.

The third registration section 313 of the management server 30 receives the electronic receipt information transmitted from the electronic receipt server 20. The third registration section 313 registers various kinds of information included in the received electronic receipt information in the corresponding columns of the purchase history table 372 (refer to FIG. 6).

The electronic receipt supply section 314 of the management server 30 delivers the electronic receipt information associated with the member ID to the transmission destination address associated with the member ID registered in the membership table 371. Here, a method of delivering the electronic receipt information is not particularly limited, and the pull-type or the push-type method described above may be used, for example. A member who does not want the delivery of the electronic receipt information is removed from the delivery targets by registering flag information indicating that the member does not want the electronic receipt information in the membership table 371.

The electronic receipt reception section 615 of the user terminal 60 receives (acquires) the electronic receipt information delivered from the management server 30. The electronic receipt output section 616 of the user terminal 60 outputs the electronic receipt information received by the electronic receipt reception section 615 to the display unit 66 or the like.

Here, a method of acquiring the electronic receipt information is not particularly limited. For example, a pull-type acquisition method may be used. That is, the electronic receipt information may be acquired in response to transmitting an acquisition request with the member ID to the management server 30 from the user terminal 60. Alternatively, a push-type acquisition method of acquiring the electronic receipt information may be used. That is, the electronic receipt information may be automatically supplied (delivered) from the management server 30. In any cases, an email address or the like of the user terminal 60 is registered in the transmission destination address of the membership table 371.

[Reward Offer Processing]

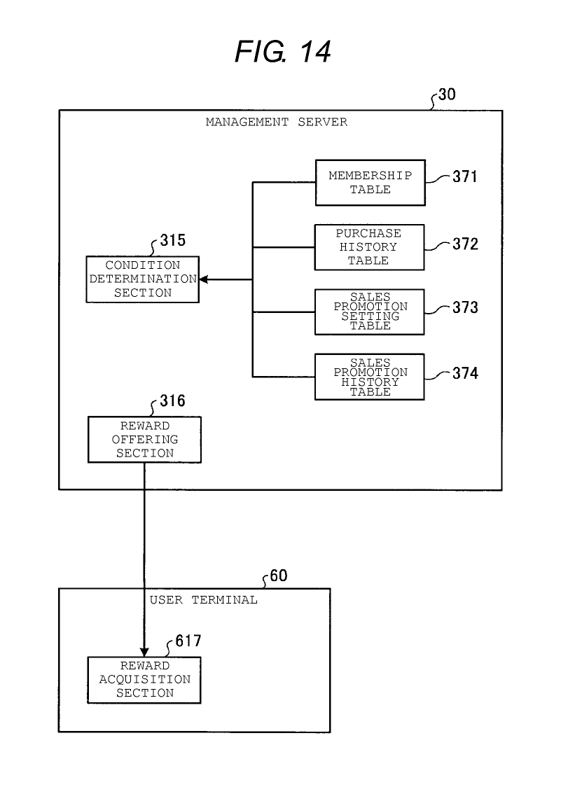

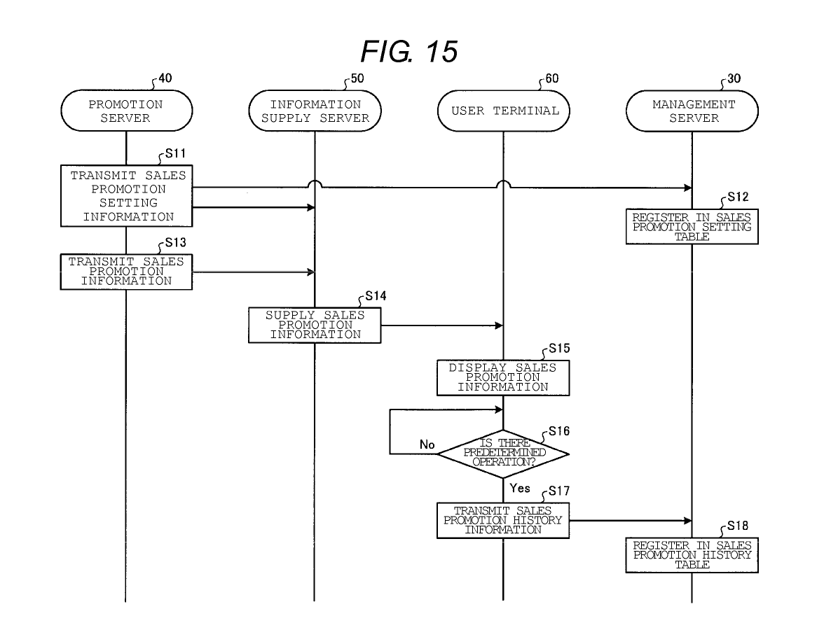

Next, a functional configuration related to the reward offering processing will be described. FIG. 14 illustrates the functional configuration related to the reward offering processing in the electronic receipt system 1.

As shown in FIG. 14, the management server 30 includes the condition determination section 315 and the reward offering section 316 as functional sections related to the reward offering processing. The user terminal 60 includes a reward acquisition section 617 as a functional section related to the reward offering processing.

The condition determination section 315 of the management server 30 determines whether or not there is a customer satisfying the provision conditions of the sales promotion information among customers who have viewed the sales promotion information, with reference to the tables stored in the storage unit 37. The condition determination section 315, for example, executes the following process for each record registered in the purchase history table 372.

First, regarding the member ID included in the record of the purchase history table 372, the condition determination section 315 extracts the sales promotion ID registered in association with the member ID from the sales promotion history table 374. Here, there maybe a limitation to extract the sales promotion ID having the sales promotion date and time registered in the sales promotion history table 374 which is before the purchase date and time included in the record of the purchase history table 372.

Next, the condition determination section 315 determines whether or not the transaction content of the member ID that satisfies the provision conditions related to the extracted sales promotion ID is present in the electronic receipt information associated with the member ID. Specifically, the condition determination section 315 compares the provision conditions of the sales promotion setting table 373 registered in association with the extracted sales promotion ID and the transaction content included in the record of the purchase history table 372 with each other. Here, the provision conditions in the sales promotion setting table 373 include the target merchandise, the target area, the target period, and the like. The transaction content in the purchase history table 372 is purchase date and time, the merchandise ID, and the purchase place.

Here, the condition determination section 315 determines whether or not the merchandise ID of the target merchandise and the merchandise ID included in the record of the purchase history table 372 coincide with each other. When the merchandise IDs coincide with each other, the condition determination section 315 determines that one of the provision conditions is satisfied. The condition determination section 315 determines whether or not the purchase place included in the purchase history table 372 corresponds to the target area, using map data indicating a location of each store SP. When it is determined that the purchase place corresponds to the target area, the condition determination section 315 determines that one of the provision conditions is satisfied. The condition determination section 315 determines whether or not the purchase date and time included in the record of the purchase history table 372 is in the target period. When it is determined that the purchase date and time is in the target period, the condition determination section 315 determines that one of the provision conditions is satisfied.

Then, the condition determination section 315 extracts the member ID of the record determined that the provision conditions are satisfied, and the application ID and the reward content set in the sales promotion setting table 373 relating to the conditions, as targets of the reward.

Among the three conditions, all or part of the conditions may be the provision conditions. For example, the purchase place may be removed from the provision conditions. When the column of the target merchandise is blank and the specific store ID is registered in the column of the target area, the merchandise ID included in the record of the purchase history table 372 may be removed from the provision conditions. The record of the purchase history table 372 in which the conditions determination is performed once, may be removed from the subsequent determination targets by setting a flag or the like.

The reward offering section 316 of the management server 30 transmits the reward content to the user terminal 60 having the corresponding application, and offer the reward to the customer of the member ID extracted as the target of the reward by the condition determination section 315. Specifically, the reward offering section 316 transmits the reward information indicating the application ID and the reward content to the transmission destination address of the member ID extracted as the target of the reward, with reference to the membership table 371.

The reward acquisition section 617 of the user terminal 60 acquires the reward supplied from the management server 30. Specifically, the reward acquisition section 617 cooperates with the application of the application ID included in the reward information, and applies the reward content included in the reward information to the application. For example, when the reward is the virtual currency or virtual items, the virtual articles are displayed in the application.

The offer of the reward is not limited to the example described above. For example, when the application in the user terminal 60 is operated under the control of an external server, the reward information may be transmitted to the external server. In this case, the reward offering section 316 of the management server 30 includes the member ID of the member who is the target of the reward in the reward information, and transmits the reward information to the external server. Accordingly, the external server may offer points or items to a user (member ID) in the application (application ID) included in the reward information.

Hereinafter, the operation of the electronic receipt system 1 will be described.

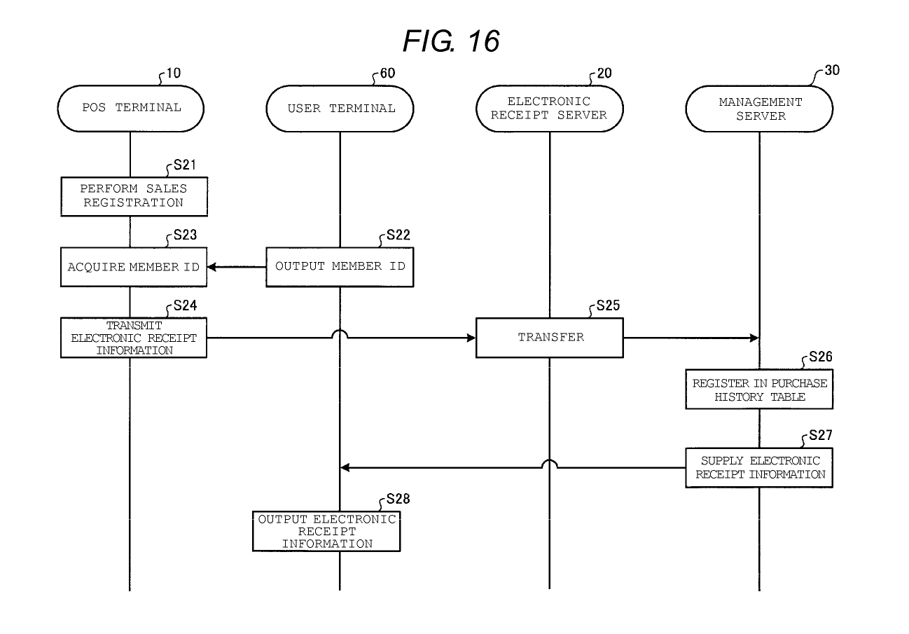

First, the operation relating to the sales promotion processing in the electronic receipt system 1 will be described with reference to FIG. 15. Here, FIG. 15 is a sequence diagram showing the sales promotion processing carried out in the electronic receipt system 1.

First, the content transmission section 411 of the promotion server 40 transmits the sales promotion setting information stored in the storage unit 47 to the management server 30 and the information supply server 50 (Step S11). In the management server 30, when the first registration section 311 receives the sales promotion setting information, the sales promotion setting information is registered in the sales promotion setting table 373 (Step S12).

The content transmission section 411 of the promotion server 40 transmits the sales promotion information having the sales promotion ID same as the sales promotion ID of the sales promotion setting information transmitted in Step S11 to the information supply server 50 (Step S13).

In the information supply server 50, when the content reception section 511 receives the sales promotion information and the sales promotion setting information, the received information is stored in the storage unit 57. Then, the sales promotion supply section 512 of the information supply server 50 supplies the sales promotion information having the sales promotion ID corresponding to the application ID to the user terminal 60, in response to the application ID received from the user terminal 60 (Step S14). Then, the sales promotion reception section 611 of the user terminal 60 receives the sales promotion information from the information supply server 50 by cooperating with the application being executed.

The sales promotion display section 612 of the user terminal 60 displays the sales promotion information received by the sales promotion reception section 611 on the screen relating to the application being executed (Step S15). Next, the sales promotion history transmission section 613 of the user terminal 60 stands by until the instruction of the predetermined operation to the sales promotion information is received (Step S16; No). When the instruction of the predetermined operation is received, the sales promotion history transmission section 613 of the user terminal 60 determines that the sales promotion information has been viewed (Step S16; Yes), and transmits the sales promotion history information indicating the viewing thereof to the management server 30 (Step S17). In the management server 30, when the second registration section 312 receives the sales promotion history information, the sales promotion history information is registered in the sales promotion history table 374 (Step S18).

By performing the process described above, it is possible to register the delivery setting information of each sales promotion ID in the sales promotion setting table 373. In addition, it is possible to supply the sales promotion information of each sales promotion ID to the user terminal 60 executing the application. Further, it is possible to register the history having the viewed sales promotion information in each of the user terminal 60 in the sales promotion history table 374 as the sales promotion history information.

Next, the operation relating to the electronic receipt processing carried out in the electronic receipt system 1 will be described with reference to FIG. 16. Here, FIG. 16 is a sequence diagram of the electronic receipt processing carried out in the electronic receipt system 1. In this process, the POS terminal 10 reads the member ID from the user terminal 60 carried by the customer (member).

First, the sales registration section 112 of the POS terminal 10 performs the sales registration of the merchandise purchased by the customer, based on the merchandise ID read by the code scanner 18 (Step S21). At that time, the member ID output section 614 of the user terminal 60 outputs (displays) the member ID stored therein (Step S22). The member ID acquisition section 111 of the POS terminal 10 acquires (reads) the member ID from the user terminal 60 carried by the customer through the ID scanner 19 or the like (Step S23).

Then, the electronic receipt transmission section 113 of the POS terminal 10 transmits the electronic receipt information including details of the merchandise subjected to the sales registration to the electronic receipt server 20 with the acquired member ID (Step S24). In the electronic receipt server 20, when the electronic receipt transfer section 211 receives the electronic receipt information and the member ID, the received information is transferred to the management server 30 (Step S25). When the transferred electronic receipt information and the member ID are received, the third registration section 313 of the management server 30 registers the received information in the purchase history table 372 (Step S26).

The electronic receipt supply section 314 of the management server 30 transmits the electronic receipt information of each member registered in the purchase history table 372 to the transmission destination address registered in the membership table 371 (Step S27).

In the user terminal 60, when the electronic receipt reception section 615 receives the electronic receipt information, the electronic receipt information is stored in the storage unit 67 or the like. The electronic receipt output section 616 of the user terminal 60 outputs the electronic receipt information received by the electronic receipt reception section 615 to the display unit 66 or the like (Step S28).

By performing the process described above, it is possible to register the details of the merchandise purchased by each member at the store SP in the purchase history table 372. In addition, it is possible to supply the electronic receipt information of each member registered in the purchase history table 372 to the transmission destination address (user terminal 60) predetermined by the member.

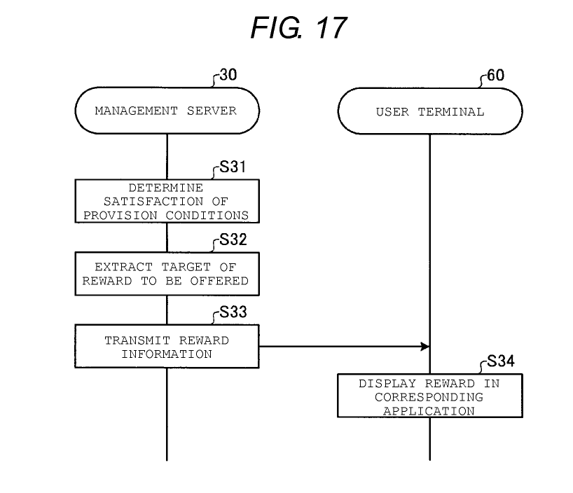

Next, the operation relating to the reward offering processing in the electronic receipt system 1 will be described with reference to FIG. 17. Here, FIG. 17 is a sequence diagram of the reward offering processing carried out in the electronic receipt system 1.

The condition determination section 315 of the management server 30 determines whether or not the transaction content satisfying the provision conditions of the sales promotion information supplied to the customer of the member ID is present in the electronic receipt information associated with the member ID, with reference to each table of the storage unit 67 (Step S31). Then, the condition determination section 315 of the management server 30 extracts the member ID of the transaction content determined that the provision conditions are satisfied and the application ID and the reward content relating to the provision conditions, as the targets of the reward to be offered (Step S32).

Then, the reward offering section 316 of the management server 30 transmits the reward information indicating the application ID and the reward content to the transmission destination address of the member ID extracted as the targets of the reward to be offered (Step S33). When the reward information is acquired by the management server 30, the reward acquisition section 617 of the user terminal 60 applies the reward content to the application of the application ID included in the reward information (Step S34).

By performing the process described above, when the purchase history in the actual store SP meets the provision conditions relating to the sales promotion information viewed in the application of the user terminal 60, it is possible to offer the predetermined reward in the application. Accordingly, it is possible to offer the virtual articles effective in the application as the reward of the merchandise purchase in the actual store SP, and therefore, it is possible to efficiently perform the sales promotion activity to the user (customer) using the application.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described here may be made without departing from the spirit of the inventions. The accompanying claims and their equivalents are intended to cover such forms or modifications as would fall within the scope and spirit of the inventions.

In the above embodiment, the member ID is acquired by the POS terminal 10 from the storage medium carried by the customer, but there is no limitation. For example, the external ID (external ID identifier) may be acquired instead. In this case, the electronic receipt transmission section 113 of the POS terminal 10 transmits the electronic receipt information including the external ID (external ID identifier), instead of the member ID, to the management server 30 through the electronic receipt server 20. The third registration section 313 of the management server 30 replaces the external ID included in the electronic receipt information with the corresponding member ID with reference to the membership table 371, and then registers the member ID in the purchase history table 372. Accordingly, it is possible to perform the same process as the process in the above embodiment. The customer whose external ID cannot be replaced with the member ID is treated as a non-member.

In the above embodiment, when the external ID is input from the user terminal 60, the customer having the corresponding member ID not registered in the membership table 371 is treated as a non-member. Alternatively, this customer may be treated as a member by assigning a new member ID. Specifically, in the management server 30, when the external ID (external ID identifier) with the corresponding member ID not registered in the membership table 371 is received, a unique member ID is assigned to the external ID and is registered in the membership table 371. Accordingly, it is possible to substantially treat all customers using the electronic receipt system as members. When other information such as a name or a transmission destination address is received with the external ID or the external ID identifier, the other information may be registered in the membership table 371.

In the above embodiment, after the sales promotion information is viewed, the reward is offered if the purchase history satisfies the provision conditions of the sales promotion information. However, the timing of offering the reward is not limited thereto. For example, the reward may be offered at the timing when the sales promotion information is viewed. Hereinafter, as a modification example of the above embodiment will be described.

### MODIFICATION EXAMPLE

First, in this modification example, an expiration date for the satisfaction of the provision conditions is set in the sales promotions setting information. By including the information indicating the expiration date in the sales promotion information, the notification of the expiration date is performed when the sales promotion information is displayed.

The operator (customer) of the user terminal 60 checks the expiration date on the display of the sales promotion information. When the operator performs the operation relating to the viewing determination of the sales promotion information, the sales promotion history transmission section 613 transmits the sales promotion history information to the management server 30.

When the sales promotion history information is received, the reward offering section 316 of the management server 30 reads out the record corresponding to the sales promotion ID included in the sales promotion history information from the sales promotion setting table 373. Then, the reward offering section 316 determines whether or not the expiration date is set in the read-out record. Here, when the expiration date is set, the reward offering section 316 transmits the application ID and the reward content set in the read-out record as the reward information to the user terminal 60 to which the sales promotion history information has been transmitted. When the expiration date is not set, the same operation as the operation in the above embodiment is performed.

In the user terminal 60, when the reward acquisition section 617 receives the reward information, the reward content is applied to the application corresponding to the application ID included in the reward information.

Regarding the member ID of the customer to which the reward offering section 316 previously offered the reward, the condition determination section 315 of the management server determines whether or not the transaction content (electronic receipt information) satisfying the provision conditions within the expiration date is registered in the purchase history table 372. Here, when it is determined that the transaction history satisfying the provision conditions within the expiration date is registered, the reward offering section 316 sets the previously offered reward.

Meanwhile, when it is determined that the transaction history satisfying the provision conditions within the expiration date is not registered, the reward offering section 316 performs an invalidation process of invalidating the previously offered reward. Here, the content of the invalidation process is not particularly limited. For example, when the reward is the points, the provided points may be invalidated. When the reward is the items, the offered items may be removed. The usage of the application may be limited until the payment corresponding to the offered reward is performed.

With the configuration described above, when the sales promotion information is viewed, it is possible to immediately offer the reward relating to the sales promotion information. Accordingly, since it is possible to decrease the stand-by time from the viewing of the sales promotion information occurred in the above embodiment to the purchase of the target merchandise or the purchase performed in the target store, it is possible to improve user convenience.

The program executed in each device of the above embodiment or the modification example is provided and pre-installed in the storage medium (ROM or storage unit) of each device, but there is no limitation. For example, the program may be recorded in a computer-readable recording medium such as a CD-ROM, a flexible disk (FD), a CD-R, or a digital versatile disk (DVD) in an installable form or an executable form. The storage medium is not limited to an independent medium from a computer or an embedded system, and a storage medium which downloads the program and temporarily stores the program transmitted through a LAN or the Internet is also included.

The program executed in each device of the above embodiment or the modification example may be stored in a computer connected to a network such as the Internet and the program may be downloaded through the network and supplied, or supplied and distributed through the network such as the Internet.

What is claimed is:

1. A system for determining a time for transmitting an electronic reward to a user computing device for display within an application installed and executed in the user computing device, comprising:
a processor configured with a sales tracking module to track: (i) sales promotion information supplied to the user computing device, (ii) viewing of the sales promotion information at the user computing device, and (iii) electronic receipts for purchases of products by a user of the user computing device, and with an electronic reward delivery module to determine, based on data tracked by the sales tracking module, whether or not conditions for transmitting the electronic reward to the user computing device have been satisfied; and
a communication unit connected to the user computing device and a server for the application through a network,
wherein, upon determining that the conditions for transmitting the electronic reward to the user computing device have been satisfied, the processor transmits the electronic reward to the server for the application through the communication unit, so that the user can be notified of the electronic reward through the user computing device while the user computing device is executing the application.

2. The system according to claim 1, further comprising:
a storage unit storing the sales promotion information in association with a product ID of a product featured in the corresponding sales promotion, and the electronic receipts, each including one or more product IDs of the products, wherein
the processor determines that one of the conditions has been satisfied, when the product IDs included in the electronic receipts include the product ID of the product featured in the sales promotion.

3. The system according to claim 2, wherein
the sales promotion information stored in the storage unit is also associated with a predetermined time period, and each of the electronic receipts stored in the storage unit includes a time at which a purchase transaction has been performed, wherein
the processor determines that another one of the conditions has been satisfied, when the time of the electronic receipt that has a product ID same as the product ID featured in the sales promotion is within the predetermined time period.

4. The system according to claim 3, wherein
the sales promotion information stored in the storage unit is also associated with a time at which the sales promotion information has been supplied to the user computing device, wherein
the processor determines that another one of the conditions has been satisfied, when the time of the electronic receipt that has a product ID same as the product ID featured in the sales promotion is subsequent to the time at which the sales promotion information has been supplied to the user computing device.

5. The system according to claim 3, wherein
the storage unit also stores a time at which the sales promotion information has been displayed on the user computing device, wherein
the processor determines that another one of the conditions has been satisfied, when the time of the electronic receipt that has a product ID same as the product ID featured in the sales promotion is subsequent to the time at which the sales promotion information has been displayed on the user computing device.

6. The system according to claim 1, further comprising:
a storage unit storing the sales promotion information in association with a store ID of a store featured in the corresponding sales promotion, and the electronic receipts, each including a store ID of a store at which a purchase transaction has been performed, wherein
the processor determines that one of the conditions has been satisfied, when the store IDs included in the electronic receipts include the store ID of the store featured in the sales promotion.

7. The system according to claim 6, wherein
the processor determines that another one of the conditions has been satisfied, when a total purchase at the store having the store ID featured in the sales promotion is greater than a predetermined value.

8. The system according to claim 1, further comprising:
a storage unit storing the sales promotion information in association with an application ID of an application featured in the corresponding sales promotion, and user data of a user including a user ID and an application ID of an application that the user computing device of the user has, wherein
the sales promotion information is supplied to the user computing device, when the application ID of the application that the user computing device of the user has is the same as the application ID of the application featured in the corresponding sales promotion.

9. The system according to claim 1, wherein
the sales promotion information is notified to the user through the user computing device while the user computing device is executing the application.

10. The system according to claim 1, wherein
the application is a game and the electronic reward is redeemable within the game.

11. The system according to claim 1, wherein
the sales promotion information includes a program that causes the user computing device to transmit, to the system, information indicating viewing of the sales promotion information.

12. The system according to claim 11, wherein
the sales promotion information also includes a program that causes the user computing device to transmit a user ID of the user to the system.

13. A method for determining a time for transmitting an electronic reward to a user computing device for display within an application installed and executed in the user computing device, comprising:
tracking data including: (i) sales promotion information supplied to the user computing device, (ii) viewing of the sales promotion information at the user computing device, and (iii) electronic receipts for purchases of products by a user of the user computing device;
determining, based on the tracked data, whether or not conditions for transmitting the electronic reward to the user computing device have been satisfied; and
upon determining that the conditions for transmitting the electronic reward to the user computing device have been satisfied, transmitting the electronic reward to a server for the application, so that the user can be notified of the electronic reward through the user computing device while the user computing device is executing the application.

14. The method according to claim 13, wherein
the sales promotion information is stored in association with a product ID of a product featured in the corresponding sales promotion,
each of the electronic receipts includes one or more product IDs of the products, and
one of the conditions is determined to have been satisfied, when the product IDs included in the electronic receipts include the product ID of the product featured in the sales promotion.

15. The method according to claim 14, wherein
the sales promotion information stored in the storage unit is also associated with a predetermined time period,
each of the electronic receipts includes a time at which a purchase transaction has been performed, and
another one of the conditions is determined to have been satisfied, when the time of the electronic receipt that has a product ID same as the product ID featured in the sales promotion is within the predetermined time period.

16. The method according to claim 11, wherein
the sales promotion information is notified to the user through the user computing device while the user computing device is executing the application.

17. The method according to claim 11, wherein
the application is a game and the electronic reward is redeemable in the game.

18. The method according to claim 11, wherein
the sales promotion information includes a program that causes the user computing device to transmit, to the system, information indicating viewing of the sales promotion information.

19. A system for determining a time for transmitting an electronic reward to a user computing device for display within an application installed and executed in the user computing device, comprising:
a processor configured with a sales tracking module to track: (i) sales promotion information supplied to the user computing device, (ii) viewing of the sales promotion information at the user computing device, and (iii) electronic receipts of purchases of products by a user of the user computing device, and with an electronic reward delivery module to determine, based on data tracked by the sales tracking module, whether or not conditions for transmitting the electronic reward to the user computing device have been satisfied; and
a communication unit connected to the user computing device through a network,
wherein, upon determining that the conditions for transmitting the electronic reward to the user computing device have been satisfied, the processor transmits the electronic reward to the user computing device through the communication unit, so that the user can be notified of the electronic reward through the user computing device while the user computing device is executing the application.
